(19) United States
(12) Patent Application Publication
(10) Pub. No.: US 2023/0296298 A1
(43) Pub. Date: Sep. 21, 2023

(54) BATTERY TEMPERATURE CONTROL SYSTEM

(71) Applicant: KABUSHIKI KAISHA TOYOTA JIDOSHOKKI, Kariya-shi, Aichi (JP)

(72) Inventor: Yuki YOKO, Aichi-ken (JP)

(73) Assignee: KABUSHIKI KAISHA TOYOTA JIDOSHOKKI, Kariya-shi, Aichi (JP)

(21) Appl. No.: 18/021,512

(22) PCT Filed: Jun. 10, 2021
(86) PCT No.: PCT/JP2021/022184

§ 371 Date: Feb. 15, 2023

(30) Foreign Application Priority Data
Aug. 18, 2020 (JP) 2020-137823

(51) Int. Cl. F25B 41/20; F25B 13/00; H01M 10/6569

(52) U.S. Cl. CPC F25B 41/20; F25B 13/00; H01M 10/6569; F25B 2600/2501

(57) ABSTRACT

A battery temperature control system includes: a refrigeration cycle including a compressor and a heat exchanger; an accumulator; a condenser; a bypass for supplying refrigerant discharged from the compressor to the heat exchanger while bypassing the condenser; a valve mechanism; a temperature detector; a controller configured to switch the valve mechanism; and an introduction passage branched off from a passage extending from a discharge port of the compressor to a position in the refrigeration cycle upstream of the heat exchanger. The introduction passage supplies the refrigerant reduced in pressure to a part of a passage extending from a position in the refrigeration cycle downstream of the accumulator or downstream of the heat exchanger to a position in the refrigeration cycle upstream of the accumulator. The controller adjusts an opening degree of the variable throttle disposed in the introduction passage depending on a temperature detected by the temperature detector.

### TECHNICAL FIELD

The present invention relates to a battery temperature control system including a refrigeration cycle.

### BACKGROUND ART

Patent Document 1, for example, is known as a battery temperature control system configured to control a temperature of a battery module by using a refrigeration cycle. In Patent Document 1, heat exchange is performed between liquid refrigerant and the battery module via a heat exchanger, so that the battery module is cooled by latent heat that is necessary for the change of the liquid refrigerant to the gas refrigerant. Further in Patent Document 1, a heater is disposed between the heat exchanger and a condenser. The heater is activated to heat refrigerant to be supplied to the heat exchanger so as to warm the battery module. According to this configuration, gas refrigerant heated and evaporated by the heater is supplied to the heat exchanger, so that heat exchange between the gas refrigerant and the battery module is performed via the heat exchanger to warm the battery module.

### Citation List

### Patent Document

Patent Document 1: Japanese Patent Application Publication No. 2019-16584

### SUMMARY OF INVENTION

### Technical Problem

However, the temperature of the gas refrigerant, which has been heated and evaporated by the heater and supplied to the heat exchanger, gradually decreases with progression of the heat exchange between the gas refrigerant and the battery module via the heat effector. The heat exchange between the refrigerant and the battery module by the heat exchanger stops when the temperature of the gas refrigerant decreases to the temperature of the battery module, so that the battery module cannot be warmed by the refrigerant. As a result, the whole of the battery module may not uniformly warm up.

The present invention, which has been made in light of the above-mentioned problem, is directed to providing a battery temperature control system that is capable of uniformly warming the whole of a battery module.

### Solution to Problem

A battery temperature control system that solves the above-mentioned problem comprises: a refrigeration cycle including a compressor configured to compress refrigerant and discharge the refrigerant, a throttle configured to reduce a pressure of the refrigerant discharged from the compressor, and a heat exchanger through which the refrigerant reduced in pressure flows and which is configured to perform heat exchange with a battery module; an accumulator disposed in a part of a passage extending from an outlet of the heat exchanger to a suction port of the compressor, and configured to allow outflow of gas refrigerant contained in the refrigerant flowing to the compressor; and an introduction passage branched off from a passage extending from a discharge port of the compressor to a position in the refrigeration cycle upstream of the heat exchanger, wherein the introduction passage is connected to a part of a passage extending from a position in the refrigeration cycle downstream of the accumulator, or a position in the refrigeration cycle downstream of the heat exchanger, to a position in the refrigeration cycle upstream of the accumulator to supply the refrigerant reduced in pressure to the part of the passage extending from the position in the refrigeration cycle downstream of the accumulator, or the position in the refrigeration cycle downstream of the heat exchanger, to the position in the refrigeration cycle upstream of the accumulator.

This configuration allows the refrigerant reduced in pressure to be supplied, through the introduction passage, to the part of the passage extending from the position in the refrigeration cycle downstream of the accumulator, or the position in the refrigeration cycle downstream of the heat exchanger, to the position in the refrigeration cycle upstream of the accumulator from the part of the passage extending from the discharge port of the compressor to the position in the refrigeration cycle upstream of the heat exchanger. Accordingly, the refrigerant in the accumulator is heated, so that the saturated vapor pressure at an outlet of the accumulator increases. Thus, the saturated vapor temperature as a temperature of the gas refrigerant at the outlet of the accumulator increases because of thermodynamic properties of the refrigerant. As the saturated vapor temperature of the gas refrigerant at the outlet of the accumulator increases, the isotherm of the gas refrigerant in the two-phase region rises. Accordingly, the condensation of the refrigerant starts at a higher temperature than a temperature in a case where the refrigerant in the accumulator is not heated. The heat exchanger performs heat exchange between the gas refrigerant flowing through the heat exchanger and the battery module, and the temperature of the gas refrigerant flowing through the heat exchanger reaches the saturated vapor temperature before decreasing to the temperature of the battery module, so that the condensation of the gas refrigerant starts, and the battery module is warmed by latent heat of condensation that is necessary for the change of the gas refrigerant to the liquid refrigerant. At this time, the temperature of the refrigerant follows an isotherm, so that the temperature of the refrigerant is constant. The temperature difference between the refrigerant and the battery module is maintained, so that the whole of the battery module may be uniformly warmed.

In the battery temperature control system, a flow rate of the refrigerant flowing into the heat exchanger may be larger than a flow rate of the refrigerant flowing into the introduction passage.

For example, it may be suppressed that a decrease of the flow rate of the refrigerant flowing into the heat exchanger may occur since the flow rate of the refrigerant flowing into the introduction passage is larger than the flow rate of the refrigerant flowing into the heat exchanger, so that the battery module may be efficiently warmed.

In the battery temperature control system, the introduction passage may be branched off at the position in the refrigeration cycle downstream of the throttle from the passage extending from the discharge port of the compressor to the position in the refrigeration cycle upstream of the heat exchanger.

This configuration eliminates the need for a throttle in the introduction passage to reduce the pressure of the refrigerant to be supplied to the part of the passage extending from the position in the refrigeration cycle downstream of the accumulator, or the position in the refrigeration cycle downstream of the heat exchanger, to the position in the refrigeration cycle upstream of the accumulator, for example, thereby simplifying the configuration of the battery temperature control system.

The battery temperature control system may include: a condenser configured to condense the refrigerant discharged from the compressor; a bypass for supplying the refrigerant discharged from the compressor to the heat exchanger, while bypassing the condenser; a valve mechanism that is switchable between a first state where the valve mechanism allows a flow of the refrigerant discharged from the compressor into the condenser and cuts off a flow of the refrigerant discharged from the compressor into the bypass and the introduction passage, and a second state where the valve mechanism cuts off the flow of the refrigerant discharged from the compressor into the condenser and allows the flow of the refrigerant discharged from the compressor into the bypass and the introduction passage; a temperature detector configured to detect a temperature of the battery module; and a controller configured to switch the valve mechanism from the first state to the second state when the temperature detected by the temperature detector is equal to or lower than a predetermined threshold temperature.

According to this configuration, the controller switches the valve mechanism from the first state to the second state when the temperature detected by the temperature detector is equal to or lower than the predetermined threshold temperature. Accordingly, when the temperature detected by the temperature detector is equal to or lower than the predetermined threshold temperature, the high-temperature and high-pressure refrigerant discharged from the compressor may flow through the bypass and be reduced in pressure by flowing through the throttle, so that the high-temperature and low-pressure refrigerant may flow into the heat exchanger. The controller therefore allows the refrigerant reduced in pressure to be supplied, through the introduction passage, to the part of the passage extending from the position in the refrigeration cycle downstream of the accumulator, or the position in the refrigeration cycle downstream of the heat exchanger, to the position in the refrigeration cycle upstream of the accumulator from the part of the passage extending from the discharge port of the compressor to the position in the refrigeration cycle upstream of the heat exchanger, when the temperature detected by the temperature detector is equal to or lower than the predetermined threshold temperature. Accordingly, when the temperature detected by the temperature detector is equal to or lower than the predetermined threshold, the refrigerant in the accumulator is heated, so that the saturated vapor pressure at the outlet of the accumulator increases.

The battery temperature control system may include: a condenser configured to condense the refrigerant discharged from the compressor; a supply device configured to supply to the condenser a heat exchange medium for cooling the refrigerant flowing through the condenser; a controller configured to switch between a first state where the supply device is activated to supply the heat exchange medium to the condenser and a second state where the supply device is stopped to stop supplying the heat exchange medium to the condenser; and a temperature detector configured to detect a temperature of the battery module, and the controller may switch from the first state to the second state when the temperature detected by the temperature detector is equal to or lower than a predetermined threshold temperature.

According to this configuration, the controller stops the supply device to switch from the first state to the second state so as to stop supplying the heat exchange medium to the condenser when the temperature detected by the temperature detector is equal to or lower than the predetermined threshold temperature, so that the high-temperature and high-pressure refrigerant discharged from the compressor is reduced in pressure by flowing through the throttle without being condensed by the condenser. Accordingly, the high-temperature and low-pressure refrigerant reduced in pressure by the throttle may flow into the heat exchanger when the temperature detected by the temperature detector is equal to or lower than the predetermined threshold temperature. The controller therefore allows the refrigerant reduced in pressure to be supplied, through the introduction passage, to the part of the passage extending from the position in the refrigeration cycle downstream of the accumulator or the position in the refrigeration cycle downstream of the heat exchanger to the position in the refrigeration cycle upstream of the accumulator from the part of the passage extending from the discharge port of the compressor to the position in the refrigeration cycle upstream of the heat exchanger, when the temperature detected by the temperature detector is equal to or lower than the predetermined threshold temperature. Accordingly, when the temperature detected by the temperature detector is equal to or lower than the predetermined threshold, the refrigerant in the accumulator is heated, so that the saturated vapor pressure at the outlet of the accumulator increases.

In the battery temperature control system, the introduction passage may be provided with a variable throttle, and the controller may adjust an opening degree of the variable throttle depending on the temperature detected by the temperature detector.

Accordingly, the controller adjusts the flow rate of the gas refrigerant flowing through the introduction passage by adjusting the opening degree of the variable throttle depending on the temperature detected by the temperature detector, so that a decrease in efficiency of the refrigeration cycle may be suppressed and the whole of the battery module may be uniformly warmed.

### Advantageous Effect of Invention

The invention allows the whole of the battery module to be uniformly warmed.

### BRIEF DESCRIPTION OF DRAWINGS

FIG. 1 is a schematic diagram of a battery temperature control system according to an embodiment.

FIG. 2 is a pressure-enthalpy diagram for refrigerant.

FIG. 3 is a schematic diagram of a battery temperature control system according to another embodiment.

FIG. 4 is a schematic diagram of a battery temperature control system according to another embodiment.

FIG. 5 is a schematic diagram of a battery temperature control system according to another embodiment.

FIG. 6 is a schematic diagram of a battery temperature control system according to another embodiment.

FIG. 7 is a schematic diagram of a battery temperature control system according to another embodiment.

FIG. 8 is a schematic diagram of a battery temperature control system according to another embodiment.

FIG. 9 is a schematic diagram of a battery temperature control system according to another embodiment.

### DESCRIPTION OF EMBODIMENTS

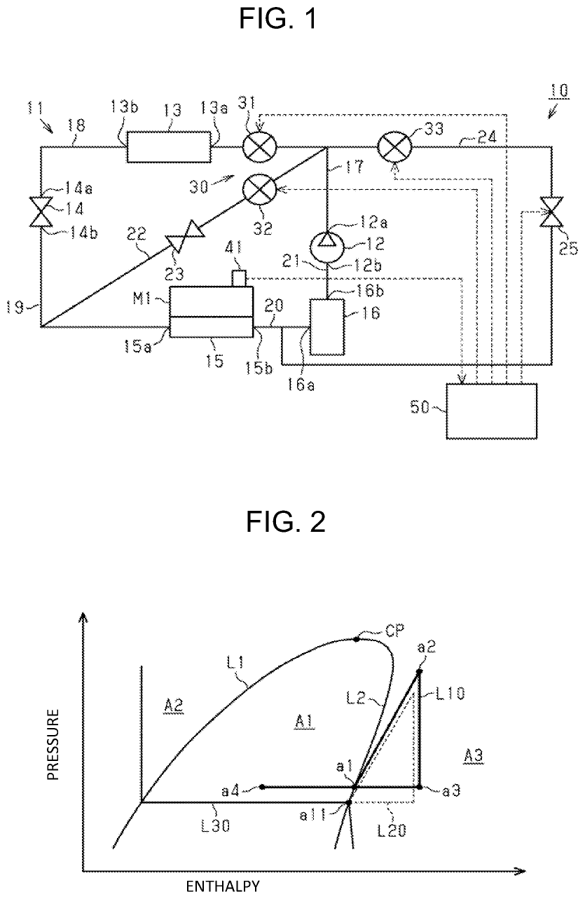

The following will describe an embodiment of a battery temperature control system with reference to accompanying FIGS. 1 and 2. The battery temperature control system according to this embodiment is mounted on a vehicle, for example.

As illustrated in FIG. 1, a battery temperature control system 10 includes a refrigeration cycle 11. The battery temperature control system 10 uses the refrigeration cycle 11 to control a temperature of a battery module M1. The battery module M1 includes fuel cells (not illustrated) arranged in rows. The fuel cells are lithium-ion battery or nickel-metal hydride battery, for example.

The refrigeration cycle 11 includes a compressor 12, a condenser 13, an expansion valve 14, an evaporator 15, and an accumulator 16. The compressor 12 is configured to compress low-temperature and low-pressure refrigerant and discharge high-temperature and high-pressure refrigerant. The condenser 13 is configured to condense the refrigerant discharged from the compressor 12. The condenser 13 condenses the refrigerant into high-temperature and high-pressure liquid refrigerant, and the expansion valve 14 reduces a pressure of the high-temperature and high-pressure liquid refrigerant into low-temperature and low-pressure liquid refrigerant. That is, the expansion valve 14 serves as a throttle configured to reduce the pressure of the refrigerant discharged from the compressor 12. The liquid refrigerant flows from the expansion valve 14 into the evaporator 15. The evaporator 15 is thermally connected to the battery module M1. The evaporator 15 serves as a heat exchanger through which the refrigerant reduced in pressure flows and which is configured to perform heat exchange with the battery module M1. The accumulator 16 is configured to allow outflow of the gas refrigerant contained in the refrigerant flowing to the compressor 12.

The compressor 12 is connected to the condenser 13 via a first pipe 17. One end of the first pipe 17 is connected to a discharge port 12a of the compressor 12. The other end of the first pipe 17 is connected to a supply port 13a of the condenser 13. The condenser 13 is connected to the expansion valve 14 via a second pipe 18. One end of the second pipe 18 is connected to an outlet port 13b of the condenser 13. The other end of the second pipe 18 is connected to a supply port 14a of the expansion valve 14.

The expansion valve 14 is connected to the evaporator 15 via a third pipe 19. One end of the third pipe 19 is connected to an outlet port 14b of the expansion valve 14. The other end of the third pipe 19 is connected to an inlet 15a of the evaporator 15. The evaporator 15 is connected to the accumulator 16 via a fourth pipe 20. One end of the fourth pipe 20 is connected to an outlet 15b of the evaporator 15. The other end of the fourth pipe 20 is connected to an inlet 16a of the accumulator 16. The accumulator 16 is connected to the compressor 12 via a fifth pipe 21. One end of the fifth pipe 21 is connected to an outlet 16b of the accumulator 16. The other end of the fifth pipe 21 is connected to a suction port 12b of the compressor 12. The accumulator 16 is disposed between the outlet 15b of the evaporator 15 and the suction port 12b of the compressor 12. The accumulator 16 is disposed in a part of a passage extending from the outlet 15b of the evaporator 15 to the suction port 12b of the compressor 12.

The battery temperature control system 10 includes a bypass 22. The bypass 22 is a pipe branched off from the first pipe 17 and connected to the third pipe 19. That is, one end and the other end of the bypass 22 are respectively connected to a part of the first pipe 17 and a part of the third pipe 19. The battery temperature control system 10 includes an orifice 23. The orifice 23 is formed in the bypass 22. The orifice 23 decreases the sectional area of a part of the bypass 22. That is, the orifice 23 is a fixed throttle.

The battery temperature control system 10 includes an introduction passage 24. The introduction passage 24 is a pipe branched off from the first pipe 17 and connected to the fourth pipe 20. That is, the introduction passage 24 is branched off from a passage extending from the discharge port 12a of the compressor 12 to a position in the refrigeration cycle upstream of the evaporator 15. The introduction passage 24 is connected to the fourth pipe 20 that is a pipe connecting the outlet 15b of the evaporator 15 to the inlet 16a of the accumulator 16. That is, the introduction passage 24 is connected to a part of a passage extending from a position in the refrigeration cycle downstream of the evaporator 15 to a position in the refrigeration cycle upstream of the accumulator 16.

One end and the other end of the introduction passage 24 are respectively connected to a part of the first pipe 17 and a part of the fourth pipe 20. The one end of the introduction passage 24 is connected to the first pipe 17 at a connecting position where the one end of the bypass 22 is connected to the first pipe 17. A sectional area of the introduction passage 24 is smaller than a sectional area of the bypass 22. That is, a flow rate of the refrigerant flowing into the evaporator 15 is larger than a flow rate of the refrigerant flowing into the introduction passage 24. The introduction passage 24 is provided with a variable throttle 25. The variable throttle 25 reduces the pressure of the refrigerant flowing through the introduction passage 24. That is, the introduction passage 24 supplies the refrigerant reduced in pressure to a part of the passage extending from the position in the refrigeration cycle downstream of the evaporator 15 to the position in the refrigeration cycle upstream of the accumulator 16.

The battery temperature control system 10 includes a valve mechanism 30. The valve mechanism 30 includes a first switching valve 31, a second switching valve 32, and a third switching valve 33. The first switching valve 31 is disposed in a part of the first pipe 17 between the connecting position of the first pipe 17 with the bypass 22 and the condenser 13. The first switching valve 31 is an on-off valve. The second switching valve 32 is disposed in a part of the bypass 22 between the orifice 23 and the first pipe 17. The second switching valve 32 is an on-off valve. The third switching valve 33 is disposed in a part of the introduction passage 24 between the variable throttle 25 and the first pipe 17. The third switching valve 33 is an on-off valve.

The battery temperature control system 10 includes a temperature sensor 41 that serves as a temperature detector configured to detect a temperature of the battery module M1. The temperature sensor 41 is configured to detect a temperature of a part of the battery module M1 corresponding to the inlet 15a of the evaporator 15 and a temperature of a part of the battery module M1 corresponding to the outlet 15b of the evaporator 15.

The battery temperature control system 10 includes a control device 50. The control device 50 includes a central processing unit (CPU). The control device 50 includes a memory that is formed of a read-only memory (ROM) previously storing information, such as various programs or maps, a random access memory (RAM) temporarily storing information, such as operation results of the CPU, or the like. The control device 50 further includes a time counter, input interface, output interface, and the like.

The control device 50 is electrically connected to the first switching valve 31. The control device 50 controls the activation of the first switching valve 31. The control device 50 is electrically connected to the second switching valve 32. The control device 50 controls the activation of the second switching valve 32. The control device 50 is electrically connected to the third switching valve 33. The control device 50 controls the activation of the third switching valve 33. The control device 50 is electrically connected to the variable throttle 25. The control device 50 adjusts an opening degree of the variable throttle 25. The control device 50 is electrically connected to the temperature sensor 41. The control device 50 receives information on a temperature detected by the temperature sensor 41.

The control device 50 previously stores a cooling operation mode execution program for executing a cooling operation mode and a warm-up operation mode execution program for executing a warm-up operation mode. The control device 50 previously stores a temperature judgement program for judging whether a temperature detected by the temperature sensor 41 is equal to or lower than a predetermined threshold temperature. The control device 50 previously stores a cooling operation mode execution program for executing a cooling operation mode when the control device 50 judges that the temperature detected by the temperature sensor 41 is not equal to or lower than the predetermined threshold temperature, in other words, when the control device 50 judges that the temperature detected by the temperature sensor 41 is higher than the predetermined threshold temperature. Further, the control device 50 previously stores a warm-up operation mode execution program for executing a warm-up operation mode when the control device 50 judges that the temperature detected by the temperature sensor 41 is equal to or lower than the predetermined threshold temperature.

The control device 50 previously stores a program for controlling activation of the first switching valve 31, the second switching valve 32, and the third switching valve 33 when the cooling operation mode is executed so that the first switching valve 31 opens and the second switching valve 32 and the third switching valve 33 close. When the control device 50 executes the cooling operation mode, the valve mechanism 30 enters a first state where the valve mechanism 30 allows a flow of the refrigerant discharged from the compressor 12 into the condenser 13 and cuts off a flow of the refrigerant discharged from the compressor 12 into the bypass 22 and the introduction passage 24.

The control device 50 previously stores a program for controlling activation of the first switching valve 31, the second switching valve 32, and the third switching valve 33 when the warm-up operation mode is executed so that the first switching valve 31 closes and the second switching valve 32 and the third switching valve 33 open. When the control device 50 executes the warm-up operation mode, the valve mechanism 30 enters a second state where the valve mechanism 30 cuts off the flow of the refrigerant discharged from the compressor 12 into the condenser 13 and allows the flow of the refrigerant discharged from the compressor 12 into the bypass 22 and the introduction passage 24. The valve mechanism 30 is switchable between the first state and the second state. The control device 50 serves as a controller configured to switch the valve mechanism 30 from the first state to the second state when the temperature detected by the temperature sensor 41 is equal to or lower than the predetermined threshold temperature.

The control device 50 previously stores a judgement program for judging, when the warm-up operation mode is executed, whether a temperature difference between the temperature of the part of the battery module M1 corresponding to the inlet 15a of the evaporator 15 and the temperature of the part of the battery module M1 corresponding to the outlet 15b of the evaporator 15 is greater than a predetermined temperature difference. The control device 50 previously stores a program for increasing the opening degree of the variable throttle 25 when the control device 50 judges that the temperature difference between the temperature of the part of the battery module M1 corresponding to the inlet 15a of the evaporator 15 and the temperature of the part of the battery module M1 corresponding to the outlet 15b of the evaporator 15 is greater than the predetermined temperature difference.

Further, the control device 50 previously stores a program for decreasing the opening degree of the variable throttle 25 when the temperature difference between the temperature of the part of the battery module M1 corresponding to the inlet 15a of the evaporator 15 and the temperature of the part of the battery module M1 corresponding to the outlet 15b of the evaporator 15 is equal to or smaller than the predetermined temperature difference. That is, the control device 50 previously stores a control program for adjusting the opening degree of the variable throttle 25 depending on a temperature detected by the temperature sensor 41. Thus, the control device 50 adjusts the opening degree of the variable throttle 25 depending on a temperature detected by the temperature sensor 41.

Next, the following will explain the operation according to the embodiment.

When the control device 50 judges that the temperature detected by the temperature sensor 41 is higher than the predetermined threshold temperature, the control device 50 executes the cooling operation mode and controls the activation of the first switching valve 31, the second switching valve 32, and the third switching valve 33 so that the first switching valve 31 opens and the second switching valve 32 and the third switching valve 33 close.

The high-temperature and high-pressure gas refrigerant discharged from the discharge port 12a of the compressor 12 into the first pipe 17 is supplied to the condenser 13 through the first pipe 17 and the supply port 13a of the condenser 13. The condenser 13 performs heat exchange between the gas refrigerant supplied to the condenser 13 and ambient air, for example, to condense the gas refrigerant into the liquid refrigerant. The refrigerant condensed by the condenser 13 into the high-temperature and high-pressure liquid refrigerant is discharged from the outlet port 13b of the condenser 13 into the second pipe 18 and flows into the expansion valve 14 through the supply port 14a of the expansion valve 14, and the high-temperature and high-pressure refrigerant is reduced in pressure while flowing through the expansion valve 14 so that the low-temperature and low-pressure liquid refrigerant is discharged into the third pipe 19 through the outlet port 14b of the expansion valve 14. The liquid refrigerant discharged into the third pipe 19 enters the inlet 15a of the evaporator 15 and flows through the evaporator 15. The evaporator 15 performs heat exchange between the liquid refrigerant flowing through the evaporator 15 and the battery module M1 to cool the battery module M1 with latent heat that is necessary for the change of the liquid refrigerant to the gas refrigerant.

The refrigerant flowing through the evaporator 15 further flows into the fourth pipe 20 through the outlet 15b of the evaporator 15. The refrigerant in the fourth pipe 20 is supplied to the accumulator 16 through the inlet 16a of the accumulator 16, and separated into the liquid refrigerant and the gas refrigerant in the accumulator 16. The liquid refrigerant in the accumulator 16 is stored in the accumulator 16. The gas refrigerant in the accumulator 16 is discharged into the fifth pipe 21 through the outlet 16b of the accumulator 16 and introduced into the compressor 12 through the fifth pipe 21 and the suction port 12b of the compressor 12.

When the control device 50 judges that the temperature detected by the temperature sensor 41 is equal to or lower than the predetermined threshold temperature, the control device 50 executes the warm-up operation mode and controls the activation of the first switching valve 31, the second switching valve 32, and the third switching valve 33 so that the first switching valve 31 closes and the second switching valve 32 and the third switching valve 33 open.

FIG. 2 is a pressure-enthalpy diagram for refrigerant. In FIG. 2, the horizontal axis represents enthalpy of refrigerant, and the vertical axis represents pressure of refrigerant. As shown in FIG. 2, the left part and the right part of an upward curved line with respect to the critical point CP are a saturated liquid line L1 and a saturated vapor line L2, respectively. An area surrounded by the saturated liquid line L1 and the saturated vapor line L2 is a two-phase region A1 where the refrigerant is in a gas-liquid phase state. The area to the left of the saturated liquid line L1 is an overcooled liquid region A2 where the refrigerant is in an overcooled liquid state. The area to the right of the saturated vapor line L2 is an overheated gas region A3 where the refrigerant is in an overheated gas state.

In FIG. 2, a solid line L10 represents a state of the refrigeration cycle 11 when the control device 50 executes the warm-up operation mode. A state point a1 of the solid line L10 on the saturated vapor line L2 represents a state of the gas refrigerant at the outlet 16b of the accumulator 16. The gas refrigerant at the outlet 16b of the accumulator 16 is saturated vapor.

In FIG. 2, a dashed line L20 represents, as a comparative example, a state of the refrigeration cycle 11 of the battery temperature control system 10 provided without the introduction passage 24. A state point all of the dashed line L20 on the saturated vapor line L2 represents a state of the gas refrigerant at the outlet 16b of the accumulator 16.

According to this embodiment, when the control device 50 executes the warm-up operation mode, the third switching valve 33 opens so that the gas refrigerant discharged from the compressor 12 is partly introduced into the fourth pipe 20 through the introduction passage 24. The refrigerant in the fourth pipe 20 is heated by the gas refrigerant introduced from the introduction passage 24 into the fourth pipe 20. The heated refrigerant is supplied to the accumulator 16 through the fourth pipe 20 and the inlet 16a of the accumulator 16, so that the refrigerant in the accumulator 16 is heated. As can be seen by comparing the state point a1 of the solid line L10 with the state point all of the dashed line L20, the saturated vapor pressure at the outlet 16b of the accumulator 16 increases in comparison with those in a case where the refrigerant in the accumulator 16 is not heated. Thus, the saturated vapor temperature as a temperature of the gas refrigerant at the outlet 16b of the accumulator 16 increases because of thermodynamic properties of the refrigerant. As the saturated vapor temperature of the gas refrigerant at the outlet 16b of the accumulator 16 increases, the isotherm of the gas refrigerant in the two-phase region A1 rises. Accordingly, condensation of the refrigerant starts at a higher temperature than the temperature in a case where the refrigerant in the accumulator 16 is not heated.

For example, a solid line L30 in FIG. 2 represents an isotherm of the temperature of the part of the battery module M1 corresponding to the outlet 15b of the evaporator 15. A flow rate of the gas refrigerant flowing through the introduction passage 24, i.e., a sectional area of the introduction passage 24, is previously determined so that the isotherm of the temperature of the refrigerant flowing through the fourth pipe 20 rises above the isotherm of the temperature of the part of the battery module M1 corresponding to the outlet 15b of the evaporator 15 as the refrigerant flowing through the fourth pipe 20 is heated by the gas refrigerant introduced from the introduction passage 24 into the fourth pipe 20.

The gas refrigerant introduced from the outlet 16b of the accumulator 16 into the suction port 12b of the compressor 12 through the fifth pipe 21 is compressed by the compressor 12. The gas refrigerant thus becomes high-temperature and high-pressure gas refrigerant as indicated by the state point a2 on the solid line L10 in the overheated gas region A3. The high-temperature and high-pressure gas refrigerant discharged from the discharge port 12a of the compressor 12 into the first pipe 17 partly flows into the bypass 22 from the first pipe 17. The gas refrigerant flowing through the bypass 22 is reduced in pressure, while flowing through the orifice 23, into a high-temperature and low-pressure gas refrigerant as indicated by a state point a3 on the solid line L10 in the overheated gas region A3. That is, the orifice 23 serves as a throttle configured to reduce the pressure of the refrigerant discharged from the compressor 12.

The gas refrigerant reduced in pressure by the orifice 23 into the high-temperature and low-pressure gas refrigerant flows from the bypass 22 into the part of the third pipe 19, and is supplied to the inlet 15a of the evaporator 15 through the third pipe 19. That is, the bypass 22 supplies the refrigerant, which has been discharged from the compressor 12, to the evaporator 15, while bypassing the condenser 13 and the expansion valve 14.

The gas refrigerant supplied to the inlet 15a of the evaporator 15 flows through the evaporator 15. The evaporator 15 performs heat exchange between the gas refrigerant flowing through the evaporator 15 and the battery module M1. The isotherm of the temperature of the refrigerant flowing through the fourth pipe 20 rises above the isotherm of the temperature of the part of the battery module M1 corresponding to the outlet 15b of the evaporator 15 as the refrigerant flowing through the fourth pipe 20 is heated by the gas refrigerant introduced from the introduction passage 24 into the fourth pipe 20. The temperature of the gas refrigerant flowing through the evaporator 15 reaches the saturated vapor temperature before decreasing to the temperature of the battery module M1, so that the condensation of the gas refrigerant starts and the battery module M1 is warmed by latent heat of condensation that is necessary for the change of the gas refrigerant to the liquid refrigerant. At this time, the temperature of the refrigerant follows an isotherm, so that the temperature of the refrigerant is constant. The temperature difference between the refrigerant and the battery module M1 is maintained, so that the whole of the battery module M1 is uniformly warmed.

A state point a4 on the solid line L10 in the two-phase region A1 represents a state of the gas refrigerant at the outlet 15b of the evaporator 15. Part of the liquid refrigerant contained in the refrigerant flowed from the outlet 15b of the evaporator 15 is heated and evaporated by the gas refrigerant introduced from the introduction passage 24 into the fourth pipe 20 while flowing through the fourth pipe 20. The refrigerant flowing through the fourth pipe 20 is supplied to the accumulator 16 through the inlet 16a of the accumulator 16, and separated into the liquid refrigerant and the gas refrigerant in the accumulator 16. The gas refrigerant at the outlet 16b of the accumulator 16 becomes saturated vapor as indicated by the state point a1 on the solid line L10.

The control device 50 increases the opening degree of the variable throttle 25 when the control device 50 judges that the temperature difference between the temperature of the part of the battery module M1 corresponding to the inlet 15a of the evaporator 15 and the temperature of the part of the battery module M1 corresponding to the outlet 15b of the evaporator 15 is greater than the predetermined temperature difference in the warm-up operation mode. This increases the flow rate of the gas refrigerant flowing through the introduction passage 24, thereby increasing the degree of heating the refrigerant flowing through the fourth pipe 20 by the gas refrigerant introduced from the introduction passage 24 into the fourth pipe 20. As a result, the condensation of the refrigerant starts at an even higher temperature than a temperature before the degree of heating the refrigerant flowing through the fourth pipe 20 is increased. Therefore, the whole of the battery module M1 is uniformly warmed easily, even if the temperature difference between the temperature of the part of the battery module M1 corresponding to the inlet 15a of the evaporator 15 and the temperature of the part of the battery module M1 corresponding to the outlet 15b of the evaporator 15 is greater than the predetermined temperature difference.

In contrast, the control device 50 decreases the opening degree of the variable throttle 25 when the control device 50 judges that the temperature difference between the temperature of the part of the battery module M1 corresponding to the inlet 15a of the evaporator 15 and the temperature of the part of the battery module M1 corresponding to the outlet 15b of the evaporator 15 is equal to or smaller than the predetermined temperature difference in the warm-up operation mode. This decreases the flow rate of the gas refrigerant flowing through the introduction passage 24, thereby decreasing the degree of heating the refrigerant flowing through the fourth pipe 20 by the gas refrigerant introduced from the introduction passage 24 into the fourth pipe 20. As a result, the condensation of the refrigerant starts at a lower temperature than a temperature before the degree of heating the refrigerant flowing through the fourth pipe 20 is decreased.

As a result, it is prevented that unnecessary increase in the flow rate of the gas refrigerant flowing through the introduction passage 24 may occur even through the temperature difference between the temperature of the part of the battery module M1 corresponding to the inlet 15a of the evaporator 15 and the temperature of the part of the battery module M1 corresponding to the outlet 15b of the evaporator 15 is equal to or smaller than the predetermined temperature difference, so that a decrease in efficiency of the refrigeration cycle 11 is suppressed.

The opening degree of the variable throttle 25 is adjusted so that the isotherm of the temperature of the refrigerant rises above the isotherm of the temperature of the part of the battery module M1 corresponding to the outlet 15b of the evaporator 15 as the refrigerant flowing through the fourth pipe 20 is heated by the gas refrigerant introduced from the introduction passage 24 into the fourth pipe 20 even when the control device 50 decreases the opening degree of the variable throttle 25.

The aforementioned embodiment provides following advantageous effects.

(1) The battery temperature control system 10 includes the introduction passage 24 that is branched off from the passage extending from the discharge port 12a of the compressor 12 to the position in the refrigeration cycle upstream of the evaporator 15. The introduction passage 24 is connected to a part of the passage extending from the position in the refrigeration cycle downstream of the evaporator 15 to the position in the refrigeration cycle upstream of the accumulator 16 to supply the refrigerant reduced in pressure to the part of the passage extending from the position in the refrigeration cycle downstream of the evaporator 15 to the position in the refrigeration cycle upstream of the accumulator 16. This configuration allows the refrigerant reduced in pressure to be supplied, through the introduction passage 24, to the part of the passage extending from the position in the refrigeration cycle downstream of the evaporator 15 to the position in the refrigeration cycle upstream of the accumulator 16 from the part of the passage extending from the discharge port 12a of the compressor 12 to the position in the refrigeration cycle upstream of the evaporator 15. Accordingly, the refrigerant in the accumulator 16 is heated, so that the saturated vapor pressure at the outlet 16b of the accumulator 16 increases. Thus, the saturated vapor temperature as a temperature of the gas refrigerant at the outlet 16b of the accumulator 16 increases because of thermodynamic properties of the refrigerant. As the saturated vapor temperature of the gas refrigerant at the outlet 16b of the accumulator 16 increases, the isotherm of the gas refrigerant in the two-phase region A1 rises. Accordingly, condensation of the refrigerant starts at a higher temperature than the temperature in a case where the refrigerant in the accumulator 16 is not heated. The evaporator 15 performs heat exchange between the gas refrigerant flowing through the evaporator 15 and the battery module M1, and the temperature of the gas refrigerant flowing through the evaporator 15 reaches the saturated vapor temperature before decreasing to the temperature of the battery module M1. Accordingly, the condensation of the gas refrigerant starts, and the battery module M1 is warmed by latent heat of condensation that is necessary for the change of the gas refrigerant to the liquid refrigerant. At this time, the temperature of the refrigerant follows an isotherm, so that the temperature of the refrigerant is constant. The temperature difference between the refrigerant and the battery module M1 is maintained, so that the whole of the battery module M1 may be uniformly warmed.

(2) The flow rate of the refrigerant flowing into the evaporator 15 is larger than the flow rate of the refrigerant flowing into the introduction passage 24. For example, it may be suppressed that a decrease of the flow rate of the refrigerant flowing into the evaporator 15 may occur since the flow rate of the refrigerant flowing into the introduction passage 24 is larger than the flow rate of the refrigerant flowing into the evaporator 15, so that the battery module M1 may be efficiently warmed.

(3) The control device 50 switches the valve mechanism 30 from the first state to the second state when the temperature detected by the temperature sensor 41 is equal to or lower than the predetermined threshold temperature. Accordingly, when the temperature detected by the temperature sensor 41 is equal to or lower than the predetermined threshold temperature, the high-temperature and high-pressure refrigerant discharged from the compressor 12 may flow through the bypass 22 and be reduced in pressure by flowing through the orifice 23, so that the high-temperature and low-pressure refrigerant may flow into the evaporator 15. Further, when the temperature detected by the temperature sensor 41 is equal to or lower than the predetermined threshold temperature, the refrigerant reduced in pressure may be supplied, through the introduction passage 24, to the part of the passage extending from the position in the refrigeration cycle downstream of the evaporator 15 to the position in the refrigeration cycle upstream of the accumulator 16 from the part of the passage extending from the discharge port 12a of the compressor 12 to the position in the refrigeration cycle upstream of the evaporator 15. Accordingly, when the temperature detected by the temperature sensor 41 is equal to or lower than the predetermined threshold, the refrigerant in the accumulator 16 is heated, so that the saturated vapor pressure at the outlet 16b of the accumulator 16 increases.

(4) The control device 50 adjusts the opening degree of the variable throttle 25 depending on a temperature detected by the temperature sensor 41. Accordingly, the control device 50 adjusts the flow rate of the gas refrigerant flowing through the introduction passage 24 by adjusting the opening degree of the variable throttle 25 depending on a temperature detected by the temperature sensor 41, so that a decrease in efficiency of the refrigeration cycle 11 may be suppressed and the whole of the battery module M1 may be uniformly warmed.

(5) The introduction passage 24 is connected to the fourth pipe 20 that connects the outlet 15b of the evaporator 15 to the inlet 16a of the accumulator 16. This configuration eliminates the need for design change of the accumulator 16, which may be needed if the introduction passage 24 is connected to the accumulator 16, thereby simplifying the whole configuration of the refrigeration cycle 11 with the use of the existing accumulator 16.

(6) According to the battery temperature control system 10 of the present embodiment, the battery module M1 may be warmed by the evaporator 15, which is used to cool the battery module M1, so that it is not necessary to secure a contact portion of the battery module M1 with the heater in order to heat the battery module M1, so that a space around the battery module M1 may be saved.

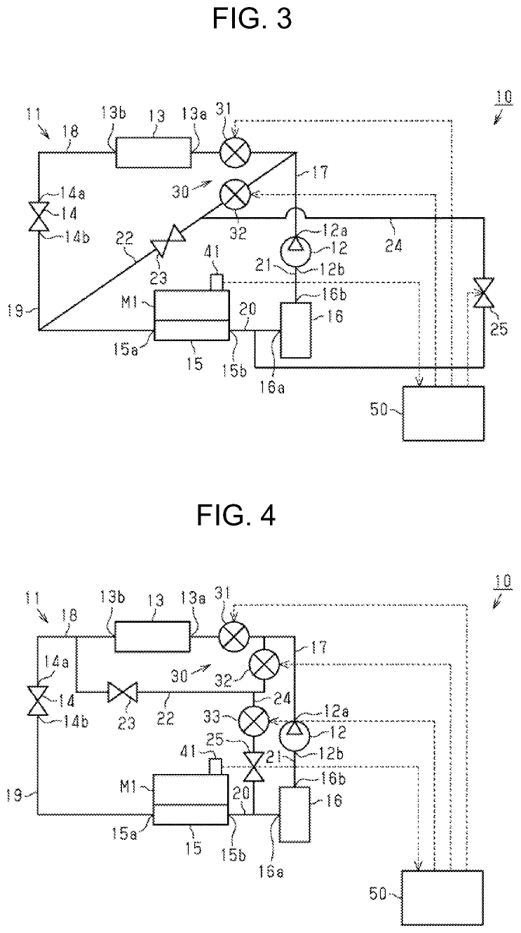

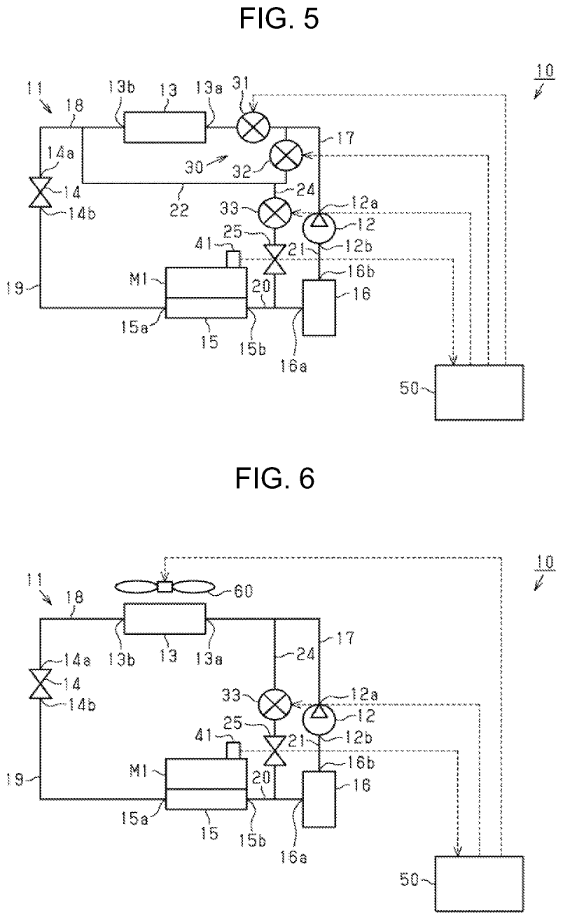

This embodiment may be modified as below. The embodiment may be combined with the following modifications within technically consistent range.
As illustrated in FIG. 3, one end of the introduction passage 24 may be connected to a part of the bypass 22 between the second switching valve 32 and the orifice 23. In this configuration, when the control device 50 executes the warm-up operation mode, the second switching valve 32 opens so that the gas refrigerant flowing through the bypass 22 partly flows into the introduction passage 24. This configuration eliminates the need for the third switching valve 33, thereby simplifying the configuration of the battery temperature control system 10.
As illustrated in FIG. 4, one end and the other end of the bypass 22 of the embodiment illustrated in FIG. 3 may be respectively connected to a part of the first pipe 17 and a part of the second pipe 18. As such, the bypass 22 may bypass the condenser 13 only. In this case, when the control device 50 executes the warm-up operation mode, the high-temperature and high-pressure gas refrigerant discharged from the discharge port 12a of the compressor 12 into the first pipe 17 flows into the bypass 22 from the first pipe 17. The gas refrigerant flowing through the bypass 22 is reduced in pressure, while flowing through the orifice 23, into a high-temperature and low-pressure gas refrigerant. The gas refrigerant reduced in pressure by the orifice 23 into the high-temperature and low-pressure gas refrigerant flows from the bypass 22 into the part of the second pipe 18, and is further reduced in pressure while flowing through the expansion valve 14. The high-temperature and low-pressure gas refrigerant further reduced in pressure by the expansion valve 14 is supplied to the inlet 15a of the evaporator 15 through the third pipe 19.
As illustrated in FIG. 4, the third switching valve 33 of the embodiment illustrated in FIG. 3 may be disposed in the introduction passage 24.
As illustrated in FIG. 5, the battery temperature control system 10 of the embodiment illustrated in FIG. 4 may be provided without the orifice 23 in the bypass 22. Even in this configuration, the gas refrigerant flows from the bypass 22 into the part of the second pipe 18 and is reduced in pressure, while flowing through the expansion valve 14, into the high-temperature and low-pressure gas refrigerant when the control device 50 executes the warm-up operation mode.
As illustrated in FIG. 6, the battery temperature control system 10 may not include the bypass 22 and the valve mechanism 30. For example, the battery temperature control system 10 may include a fan 60, and the condenser 13 may perform heat exchange between the gas refrigerant supplied to the condenser 13 and air sent by the fan 60 to the condenser 13 so as to condense the gas refrigerant. In this configuration, the air sent by the fan 60 to the condenser 13 serves as a heat exchange medium for cooling the refrigerant flowing through the condenser 13, and the fan 60 serves as a supply device that is configured to supply the heat exchange medium to the condenser 13.

The control device 50 is electrically connected to the fan 60. The control device 50 controls activation of the fan 60. The control device 50 is configured to switch between a first state where the fan 60 is activated to supply the air to the condenser 13 and a second state where the fan 60 is stopped to stop supplying the air to the condenser 13. The control device 50 switches from the first state to the second state when the temperature detected by the temperature sensor 41 is equal to or lower than the predetermined threshold temperature.

According to this configuration, the control device 50 stops the fan 60 to switch from the first state to the second state so as to stop supplying the air to the condenser 13 when the temperature detected by the temperature sensor 41 is equal to or lower than the predetermined threshold temperature, so that the high-temperature and high-pressure refrigerant discharged from the compressor 12 is reduced in pressure by flowing through the expansion valve 14 without being condensed by the condenser 13. Accordingly, the high-temperature and low-pressure refrigerant reduced in pressure by the expansion valve 14 may flow into the evaporator 15 when the temperature detected by the temperature sensor 41 is equal to or lower than the predetermined threshold temperature.

The control device 50 therefore allows the refrigerant reduced in pressure to be supplied, through the introduction passage 24, to the part of the passage extending from the position in the refrigeration cycle downstream of the evaporator 15 to the position in the refrigeration cycle upstream of the accumulator 16 from the part of the passage extending from the discharge port 12a of the compressor 12 to the position in the refrigeration cycle upstream of the evaporator 15, when the temperature detected by the temperature sensor 41 is equal to or lower than the predetermined threshold temperature. Accordingly, when the temperature detected by the temperature sensor 41 is equal to or lower than the predetermined threshold temperature, the refrigerant in the accumulator 16 is heated, so that the saturated vapor pressure at the outlet 16b of the accumulator 16 increases. As the saturated vapor pressure at the outlet 16b of the accumulator 16 increases, the saturated vapor temperature as a temperature of the gas refrigerant at the outlet 16b of the accumulator 16 increases because of thermodynamic properties of the refrigerant.

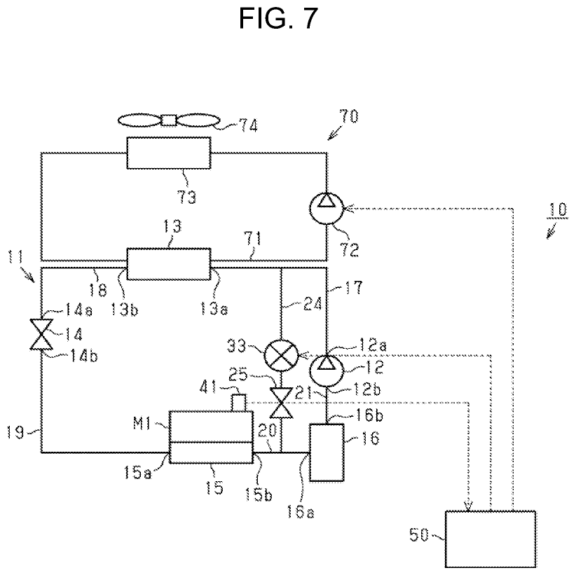

As the saturated vapor temperature of the gas refrigerant at the outlet 16b of the accumulator 16 increases, the isotherm of the gas refrigerant in the two-phase region A1 rises. Accordingly, the condensation of the refrigerant starts at a higher temperature than the temperature in a case where the refrigerant in the accumulator 16 is not heated. The evaporator 15 performs heat exchange between the gas refrigerant flowing through the evaporator 15 and the battery module M1, so that the temperature of the gas refrigerant flowing through the evaporator 15 reaches the saturated vapor temperature before decreasing to the temperature of the battery module M1. Accordingly, the condensation of the gas refrigerant starts, and the battery module M1 is warmed by latent heat of condensation that is necessary for the change of the gas refrigerant to the liquid refrigerant. At this time, the temperature of the refrigerant follows an isotherm, so that the temperature of the refrigerant is constant. The temperature difference between the refrigerant and the battery module M1 is maintained, so that the whole of the battery module M1 may be uniformly warmed.
As illustrated in FIG. 7, the battery temperature control system 10 may not include the bypass 22 and the valve mechanism 30. For example, the battery temperature control system 10 may include a coolant circuit 70, and the condenser 13 performs heat exchange between the gas refrigerant supplied to the condenser 13 and Long Life Coolant (LLC) supplied to the condenser 13 through the coolant circuit 70 so as to condense the gas refrigerant.

The coolant circuit 70 includes a circulation pipe 71 that forms a circulation passage through which the coolant circulates, a pump 72 that is configured to pump the coolant flowing through the circulation pipe 71, and a radiator 73. A part of the circulation pipe 71 passes through the condenser 13. Another part of the circulation pipe 71 passes through the radiator 73. The coolant is circulated through the circulation pipe 71 by the activated pump 72. The battery temperature control system 10 includes a coolant fan 74 configured to send air toward the radiator 73. The radiator 73 performs heat exchange between the coolant flowing through the radiator 73 and the air sent by the coolant fan 74 to the radiator 73 so as to cool the coolant. The coolant cooled by the radiator 73 flows through the condenser 13. The condenser 13 performs heat exchange between the gas refrigerant supplied to the condenser 13 and the coolant supplied to the condenser 13 so as to condense the gas refrigerant. That is, the coolant, which is circulated through the circulation pipe 71 and supplied toward the condenser 13 by the pump 72, serves as a heat exchange medium for cooling the refrigerant flowing through the condenser 13, and the pump 72 serves as a supply device that is configured to supply the heat exchange medium to the condenser 13.

The control device 50 is electrically connected to the pump 72. The control device 50 controls activation of the pump 72. The control device 50 is configured to switch between a first state where the pump 72 is activated to supply the coolant to the condenser 13 and a second state where the pump 72 is stopped to stop supplying the coolant to the condenser 13. The control device 50 switches from the first state to the second state when the temperature detected by the temperature sensor 41 is equal to or lower than the predetermined threshold temperature.

According to this configuration, the control device 50 stops the pump 72 to switch from the first state to the second state so as to stop supplying the coolant to the condenser 13 when the temperature detected by the temperature sensor 41 is equal to or lower than the predetermined threshold temperature, so that the high-temperature and high-pressure refrigerant discharged from the compressor 12 is reduced in pressure by flowing through the expansion valve 14 without being condensed by the condenser 13. Accordingly, the high-temperature and low-pressure refrigerant reduced in pressure by the expansion valve 14 may flow into the evaporator 15 when the temperature detected by the temperature sensor 41 is equal to or lower than the predetermined threshold temperature.

The control device 50 therefore allows the refrigerant reduced in pressure to be supplied, through the introduction passage 24, to the part of the passage extending from the position in the refrigeration cycle downstream of the evaporator 15 to the position in the refrigeration cycle upstream of the accumulator 16 from the part of the passage extending from the discharge port 12a of the compressor 12 to the position in the refrigeration cycle upstream of the evaporator 15, when the temperature detected by the temperature sensor 41 is equal to or lower than the predetermined threshold temperature. Accordingly, when the temperature detected by the temperature sensor 41 is equal to or lower than the predetermined threshold temperature, the refrigerant in the accumulator 16 is heated, so that the saturated vapor pressure at the outlet 16b of the accumulator 16 increases. As the saturated vapor pressure at the outlet 16b of the accumulator 16 increases, the saturated vapor temperature as a temperature of the gas refrigerant at the outlet 16b of the accumulator 16 increases because of thermodynamic properties of the refrigerant.

As the saturated vapor temperature of the gas refrigerant at the outlet 16b of the accumulator 16 increases, the isotherm of the gas refrigerant in the two-phase region A1 rises. Accordingly, the condensation of the refrigerant starts at a higher temperature than the temperature in a case where the refrigerant in the accumulator 16 is not heated. The evaporator 15 performs heat exchange between the gas refrigerant flowing through the evaporator 15 and the battery module M1, so that the temperature of the gas refrigerant flowing through the evaporator 15 reaches the saturated vapor temperature before decreasing to the temperature of the battery module M1. Accordingly, the condensation of the gas refrigerant starts, and the battery module M1 is warmed by latent heat of condensation that is necessary for the change of the gas refrigerant to the liquid refrigerant. At this time, the temperature of the refrigerant follows an isotherm, so that the temperature of the refrigerant is constant. The temperature difference between the refrigerant and the battery module M1 is maintained, so that the whole of the battery module M1 may be uniformly warmed.
As illustrated in FIG. 8, the one end and the other end of the introduction passage 24 of the embodiment illustrated in FIG. 5 may be respectively connected to a part of the third pipe 19 and a part of the fourth pipe 20. That is, the introduction passage 24 may be branched off, at a position in the refrigeration cycle downstream of the expansion valve 14, from the passage extending from the discharge port 12a of the compressor 12 to the position in the refrigeration cycle upstream of the evaporator 15.

In this case, when the control device 50 executes the warm-up operation mode, the high-temperature and high-pressure gas refrigerant discharged from the discharge port 12a of the compressor 12 into the first pipe 17 flows into the bypass 22 from the first pipe 17, and flows into the part of the second pipe 18 from the bypass 22 and is then reduced in pressure by flowing through the expansion valve 14. The gas refrigerant reduced in pressure by the expansion valve 14 into the high-temperature and low-pressure gas refrigerant is partly introduced to the fourth pipe 20 through the introduction passage 24. The refrigerant in the fourth pipe 20 is heated by the gas refrigerant introduced from the introduction passage 24 into the fourth pipe 20.

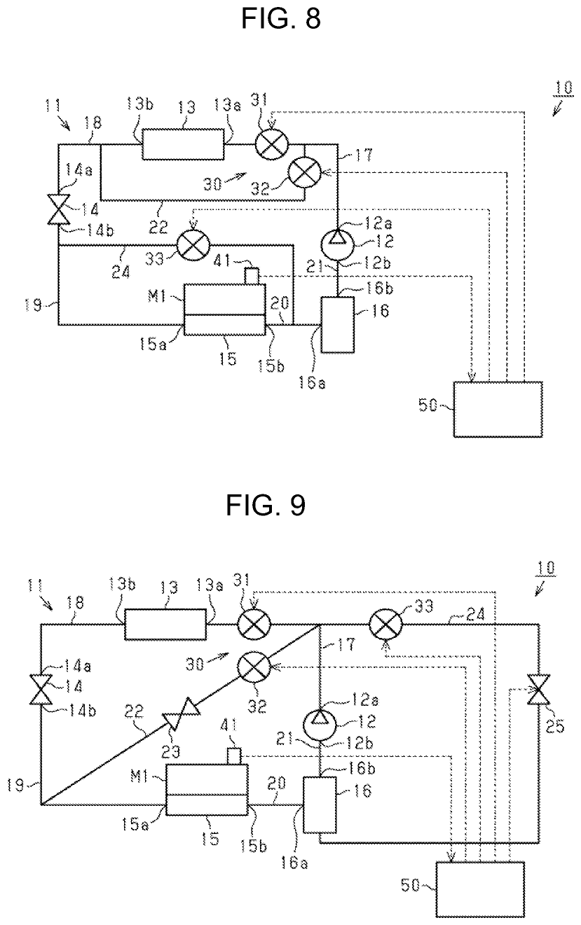

This configuration eliminates the need for a throttle in the introduction passage 24 to reduce the pressure of the refrigerant to be supplied to the part of the passage extending from the position in the refrigeration cycle downstream of the evaporator 15 to the position in the refrigeration cycle upstream of the accumulator 16, for example, thereby simplifying the configuration of the battery temperature control system 10.
As illustrated in FIG. 9, the introduction passage 24 may be connected to the accumulator 16. That is, the introduction passage 24 needs be connected to a part of the passage extending from the position in the refrigeration cycle downstream of the accumulator 16 or the position in the refrigeration cycle downstream of the evaporator 15 to the position in the refrigeration cycle upstream of the accumulator 16.
In the embodiment, the other end of the introduction passage 24 may be connected to the accumulator 16. According to this configuration, the refrigerant in the accumulator 16 is heated by the gas refrigerant introduced from the introduction passage 24 into the accumulator 16, so that the saturated vapor pressure as the pressure of the gas refrigerant at the outlet 16b of the accumulator 16 increases. That is, the introduction passage 24 only needs to introduce the gas refrigerant discharged from the compressor 12 to a position between the outlet 15b of the evaporator 15 and the outlet 16b of the accumulator 16. The refrigerant only needs to be heated by the high-temperature and high-pressure gas refrigerant at the position between the outlet 15b of the evaporator 15 and the outlet 16b of the accumulator 16. Such a configuration provides an advantageous effect similar to the advantageous effect (1) of the embodiment.
In the embodiment, the introduction passage 24 may be provided with a fixed throttle instead of the variable throttle 25. In this configuration, an opening degree of the fixed throttle needs to be previously determined such that the isotherm of the temperature of the refrigerant rises above the isotherm of the temperature of the part of the battery module M1 corresponding to the outlet 15b of the evaporator 15 as the refrigerant flowing through the fourth pipe 20 is heated by the gas refrigerant introduced from the introduction passage 24 into the fourth pipe 20.
In this embodiment, the introduction passage 24 may be provided without a throttle. In this configuration, a flow rate of the gas refrigerant flowing through the introduction passage 24, i.e., a sectional area of the introduction passage 24, is previously determined so that the isotherm of the temperature of the refrigerant rises above the isotherm of the temperature of the part of the battery module M1 corresponding to the outlet 15b of the evaporator 15 as the refrigerant flowing through the fourth pipe 20 is heated by the gas refrigerant introduced from the introduction passage 24 into the fourth pipe 20.
In this embodiment, the sectional area of the introduction passage 24 may be equal to or greater than the sectional area of the bypass 22.

### REFERENCE SIGNS LIST

M1 battery module
10 battery temperature control system
11 refrigeration cycle
12 compressor
12a discharge port
12b suction port
13 condenser
14 expansion valve serving as a throttle
15 evaporator serving as a heat exchanger
15b outlet
16 accumulator
22 bypass
23 orifice serving as a throttle
24 introduction passage
25 variable throttle
30 valve mechanism
41 temperature sensor serving as a temperature detector
50 control device serving as a controller
60 fan serving as a supply device
72 pump serving as a supply device

1. A battery temperature control system comprising:
a refrigeration cycle including:
a compressor configured to compress refrigerant and discharge the refrigerant;
a throttle configured to reduce a pressure of the refrigerant discharged from the compressor; and
a heat exchanger through which the refrigerant reduced in pressure flows and which is configured to perform heat exchange with a battery module;
an accumulator disposed in a part of a passage extending from an outlet of the heat exchanger to a suction port of the compressor, and configured to allow outflow of gas refrigerant contained in the refrigerant flowing to the compressor;
a condenser configured to condense the refrigerant discharged from the compressor;
a bypass for supplying the refrigerant discharged from the compressor to the heat exchanger, while bypassing the condenser;
a valve mechanism that is switchable between a first state where the valve mechanism allows a flow of the refrigerant discharged from the compressor into the condenser and cuts off a flow of the refrigerant discharged from the compressor into the bypass and the introduction passage, and a second state where the valve mechanism cuts off the flow of the refrigerant discharged from the compressor into the condenser and allows the flow of the refrigerant discharged from the compressor into the bypass and the introduction passage;
a temperature detector configured to detect a temperature of the battery module;
a controller configured to switch the valve mechanism from the first state to the second state when the temperature detected by the temperature detector is equal to or lower than a predetermined threshold temperature; and
an introduction passage branched off from a passage extending from a discharge port of the compressor to a position in the refrigeration cycle upstream of the heat exchanger, wherein
the introduction passage is connected to a part of a passage extending from a position in the refrigeration cycle downstream of the accumulator, or a position in the refrigeration cycle downstream of the heat exchanger, to a position in the refrigeration cycle upstream of the accumulator to supply the refrigerant reduced in pressure to the part of the passage extending from the position in the refrigeration cycle downstream of the accumulator, or the position in the refrigeration cycle downstream of the heat exchanger, to the position in the refrigeration cycle upstream of the accumulator,
the introduction passage is provided with a variable throttle, and
the controller adjusts an opening degree of the variable throttle depending on the temperature detected by the temperature detector.

2. A battery temperature control system comprising:
a refrigeration cycle including:
a compressor configured to compress refrigerant and discharge the refrigerant;
a throttle configured to reduce a pressure of the refrigerant discharged from the compressor; and
a heat exchanger through which the refrigerant reduced in pressure flows and which is configured to perform heat exchange with a battery module;
an accumulator disposed in a part of a passage extending from an outlet of the heat exchanger to a suction port of the compressor, and configured to allow outflow of gas refrigerant contained in the refrigerant flowing to the compressor;
a condenser configured to condense the refrigerant discharged from the compressor;
a supply device configured to supply to the condenser a heat exchange medium for cooling the refrigerant flowing through the condenser;
a temperature detector configured to detect a temperature of the battery module;
a controller that is switchable between a first state where the supply device is activated to supply the heat exchange medium to the condenser and a second state where the supply device is stopped to stop supplying the heat exchange medium to the condenser, the controller being configured to switch from the first state to the second state when the temperature detected by the temperature detector is equal to or lower than a predetermined threshold temperature; and
an introduction passage branched off from a passage extending from a discharge port of the compressor to a position in the refrigeration cycle upstream of the heat exchanger, the introduction passage being connected to a part of a passage extending from a position in the refrigeration cycle downstream of the accumulator, or a position in the refrigeration cycle downstream of the heat exchanger, to a position in the refrigeration cycle upstream of the accumulator to supply the refrigerant reduced in pressure to the part of the passage extending from the position in the refrigeration cycle downstream of the accumulator, or the position in the refrigeration cycle downstream of the heat exchanger, to the position in the refrigeration cycle upstream of the accumulator, wherein
the introduction passage is provided with a variable throttle, and
the controller adjusts an opening degree of the variable throttle depending on the temperature detected by the temperature detector.

3. The battery temperature control system according to claim 1, wherein a flow rate of the refrigerant flowing into the heat exchanger is larger than a flow rate of the refrigerant flowing into the introduction passage.

4. The battery temperature control system according to claim 1, wherein the introduction passage is branched off, at a position in the refrigeration cycle downstream of the throttle, from the passage extending from the discharge port of the compressor to the position in the refrigeration cycle upstream of the heat exchanger.

5. (canceled)

6. (canceled)

7. The battery temperature control system according to claim 2, wherein a flow rate of the refrigerant flowing into the heat exchanger is larger than a flow rate of the refrigerant flowing into the introduction passage.

8. The battery temperature control system according to claim 2, wherein the introduction passage is branched off, at a position in the refrigeration cycle downstream of the throttle, from the passage extending from the discharge port of the compressor to the position in the refrigeration cycle upstream of the heat exchanger.
